(19) United States
(12) Patent Application Publication
(10) Pub. No.: US 2016/0095352 A1
(43) Pub. Date: Apr. 7, 2016

(54) ELECTRONIC CIGARETTE AND BATTERY POLE PIECE PROTECTIVE BRACKET THEREOF

(71) Applicant: KIMREE HI-TECH INC., Road Town, Tortola (VG)

(72) Inventor: Qiuming LIU, Huizhou, Guangdong (CN)

(21) Appl. No.: 13/992,741

(22) PCT Filed: Jan. 23, 2013
(86) PCT No.: PCT/CN2013/070895

§ 371 Date: Jun. 8, 2013

(51) Int. Cl. A24F 47/00; H01M 2/34

(52) U.S. Cl. CPC A24F 47/008; H01M 2/34; H01M 2220/30

(57) ABSTRACT

A battery pole piece protective bracket n is entirely of a cylindrical shape. A wire passage is defined in the battery pole piece protective bracket and is axially extended through the same. At least one end surface of the battery pole piece protective bracket is provided with a protective trough recessed from the end surface for preventing contact of the battery pole piece with an external element thus further avoiding short circuit. By using entirely cylindrical shaped and axially extended wire passage, and by using a protective trough recessed from one end surface for preventing contact of the battery pole piece with an external element thus further avoiding short circuit, the battery pole piece is good insulated from external environment, no risk of short circuit exists, there is no need for attaching high temperature resistant adhesive tape or applying electric hot melt adhesive, and electronic cigarette assembling rate is increased.

### FIELD OF THE INVENTION

The present invention relates to field of electronic cigarette and more particularly, relates to an electronic cigarette and battery pole piece protective bracket thereof.

### BACKGROUND OF THE INVENTION

With people's deep understanding on risk of smoking, it has become a common object for most smokers to stop smoking and accordingly, as an alternative of traditional cigar, electronic cigarette has become popular gradually.

A prior art electronic cigarette generally is composed of an absorption stem and a power source stem. A mouthpiece and an atomization device for generating smoke are disposed in the absorption stem. A battery for supplying electric power is disposed in the power source stem. The battery pole pieces on one end portion of the battery are insulated and protected from short circuit by attachment of a high temperature resistant adhesive tape or by application of hot melt adhesive. However, short circuit will possibly occur and thus the hot melt adhesive will easily peel away due to piercing and wear of the high temperature resistant adhesive tape caused by squeezing and pressing. In addition, due to small size of the pole pieces, it is hard to attach high temperature resistant adhesive tape or apply hot melt adhesive, thus resulting in low assembly rate of the electronic cigarette.

### SUMMARY OF THE INVENTION

Accordingly, there is a need for providing a battery pole piece protective bracket for insulating the pole piece and avoiding short circuit.

Accordingly, there is also a need for an electronic cigarette for insulating the pole piece, avoiding short circuit and improving assembly rate.

The battery pole piece protective bracket provided by present invention is entirely of a cylindrical shape. A wire passage is defined in the battery pole piece protective bracket and is axially extended through the same. At least one end surface of the battery pole piece protective bracket is provided with a protective trough recessed from the end surface for preventing contact of the battery pole piece with an external element thus further avoiding short circuit.

Preferably, a plurality of gas passages extended along an axial direction of the battery pole piece protective bracket is disposed on a side of the battery pole piece protective bracket for flowing of gas therethrough.

Preferably, the wire passage is formed from the gas passage along the axial direction for receiving wires therein.

Preferably, the wire passage is a through hole running axially across the battery pole piece protective bracket for passing through the wires.

Furthermore, the present invention also provides an electronic cigarette including an absorption stem and a power source stem connected to the absorption stem. A battery is disposed in the power source stem. One end portion of the battery is equipped with the abovementioned battery pole piece protective bracket.

Preferably, the cross section of the battery pole piece protective bracket matches an inner side of the power source stem.

Preferably, the battery pole piece protective bracket is disposed on the battery at one end opposing the absorption stem.

Preferably, the battery pole piece protective bracket is also disposed on the battery at one end away from the absorption stem.

Preferably, the absorption stem includes an absorption sleeve, an atomizer disposed in the absorption sleeve, a nozzle case disposed at one end of the absorption sleeve, and a first connector disposed at the other end of the absorption sleeve for connecting with the power source stem.

Preferably, the power source stem includes a power source sleeve and a battery placed in the power source sleeve. One end of the power source sleeve is provided with a second connector connected to the first connector, while the other end thereof is provided with a switch module and a cap.

Preferably, each of the first and second connectors is composed of an external electrode ring, an insulation ring, and an internal electrode which are connected with each other sequentially.

Preferably, the atomizer includes an atomization chamber formed together by a liquid storage component and a guiding tube inserted one another and sealed at two ends, and a heater contained in the atomization chamber.

Preferably, the heater includes a liquid guiding component of which two ends extend out of an outer wall of the guiding tube and are pressed against the liquid storage component, and an electric heater coil enwound on an outer surface of the liquid guiding component.

Preferably, the two ends of the atomization chamber are sealed respectively by the nozzle case and an atomization bracket.

The electronic cigarette and battery pole piece protective bracket of the present invention has following advantages. By using entirely cylindrical shaped and axially extended wire passage, and by using a protective trough recessed from one end surface for preventing contact of the battery pole piece with an external element thus further avoiding short circuit, the battery pole piece is good insulated from external environment, no risk of short circuit exists, there is no need for attaching high temperature resistant adhesive tape or applying electric hot melt adhesive, and electronic cigarette assembling rate is increased.

### BRIEF DESCRIPTION OF THE DRAWINGS

FIG. 1 is a perspective view of a battery pole piece protective bracket according to the present invention;

FIG. 2 is a bottom plan view of the battery pole piece protective bracket of FIG. 1;

FIG. 3 is a perspective view of a battery pole piece protective bracket according to another embodiment of the present invention;

FIG. 4 is a bottom plan view of the battery pole piece protective bracket of FIG. 3;

FIG. 5 is an overall structural view of an electronic cigarette of the present invention;

FIG. 6 is a cross-section view of an electronic cigarette of the present invention;

FIG. 7 is an overall view of a power source stem of the electronic cigarette of the present invention;

FIG. 8 is an exploded view of the power source stem of the electronic cigarette of the present invention; and

FIG. 9 is a cross-sectional view of the power source stem of the electronic cigarette of the present invention.

### DETAILED DESCRIPTION OF THE INVENTION

It is noted that, in case no interference is resulted in, the embodiments and features contained therein may be combined with each other. The present invention is described in greater detail in conjunction with the accompanying drawings and embodiments.

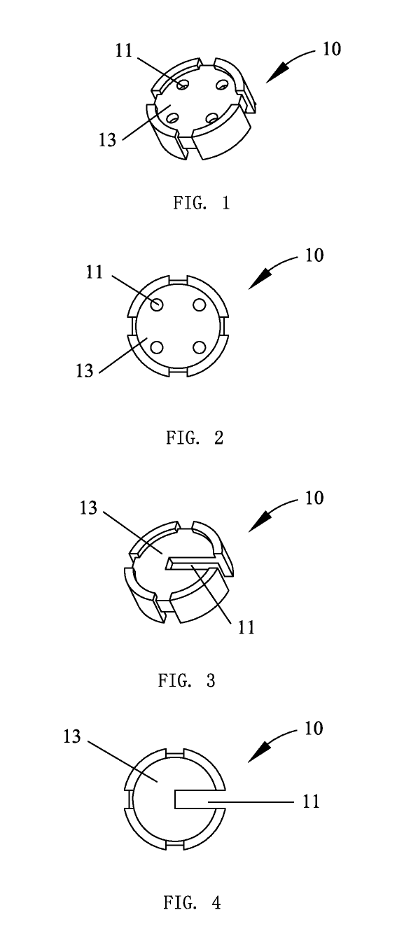

Reference is made to FIGS. 1-4. The present invention provides a battery pole piece protective bracket 10 of entirely a cylindrical shape. A wire passage 11 is defined in the battery pole piece protective bracket 10 and is axially extended through the same. At least one end surface of the battery pole piece protective bracket 10 is provided with a protective trough 13 recessed from the end surface for preventing contact of a battery pole piece 15 with an external element thus further avoiding short circuit. Specifically, in one embodiment, only one end surface of the battery pole piece protective bracket 10 facing the battery pole piece 15 is recessed to form the protective trough 13, and the battery pole piece protective bracket 10 is of a basin shape. In another embodiment, two end surfaces of the battery pole piece protective bracket 10 are recessed to form the protective trough 13 at one end surface and to form a groove at the other end surface. Preferably, the protective trough is symmetrical with the groove. The battery pole piece protective bracket 10 of this structure is robust and stable. In this embodiment, the battery pole piece protective bracket 10 is made of any one or more of silica gel, rubber, TPU, TRU and PVC. Alternatively, it is made of any one or more of plastic materials such as ABS, PC, PE, PP, PA or POM. Or, it may be made of any one or more of paper, wood or ceramic material.

As an embodiment, a plurality of gas passages extended along an axial direction of the battery pole piece protective bracket 10 is disposed on a side of the battery pole piece protective bracket 10 for flowing of gas therethrough. As another embodiment, no gas passage is defined in a side of the battery pole piece protective bracket 10 and correspondingly, the width of the wire passage 11 is greater than the diameter of the wire such that the wire passage 11 is also used as the gas passage. This structure is simple and effective.

As an embodiment, as shown in FIGS. 3-4, the wire passage 11 is a groove formed from the gas passage along the axial direction for receiving wires therein. As another embodiment, as shown in FIGS. 1-2, the wire passage 11 a through hole axially running across the battery pole piece protective bracket 10.

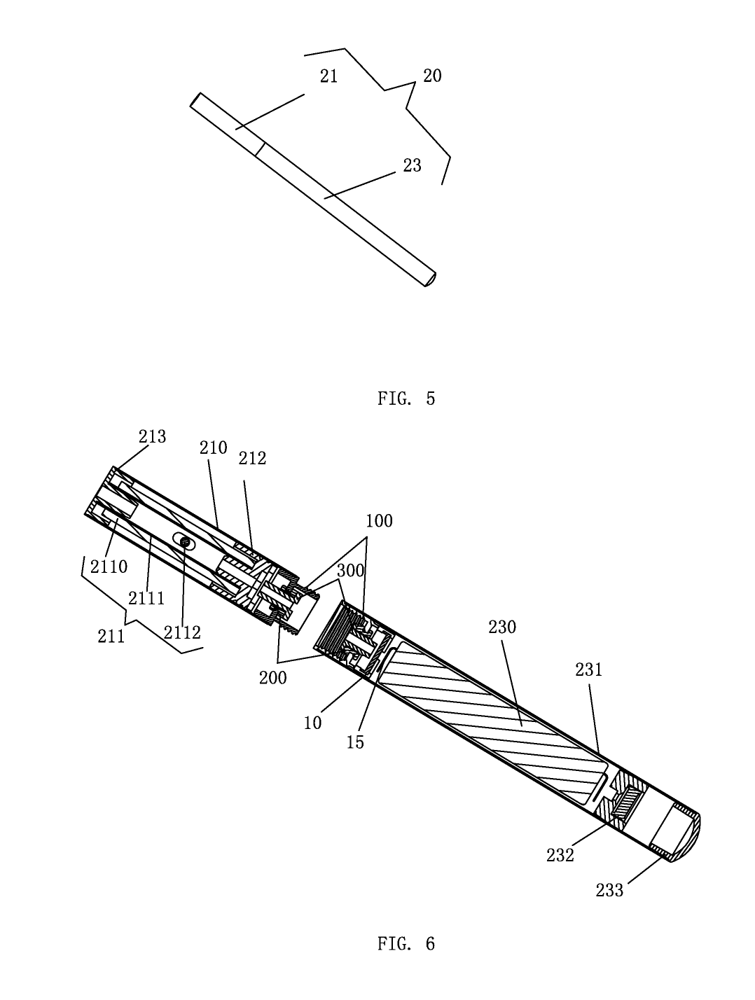

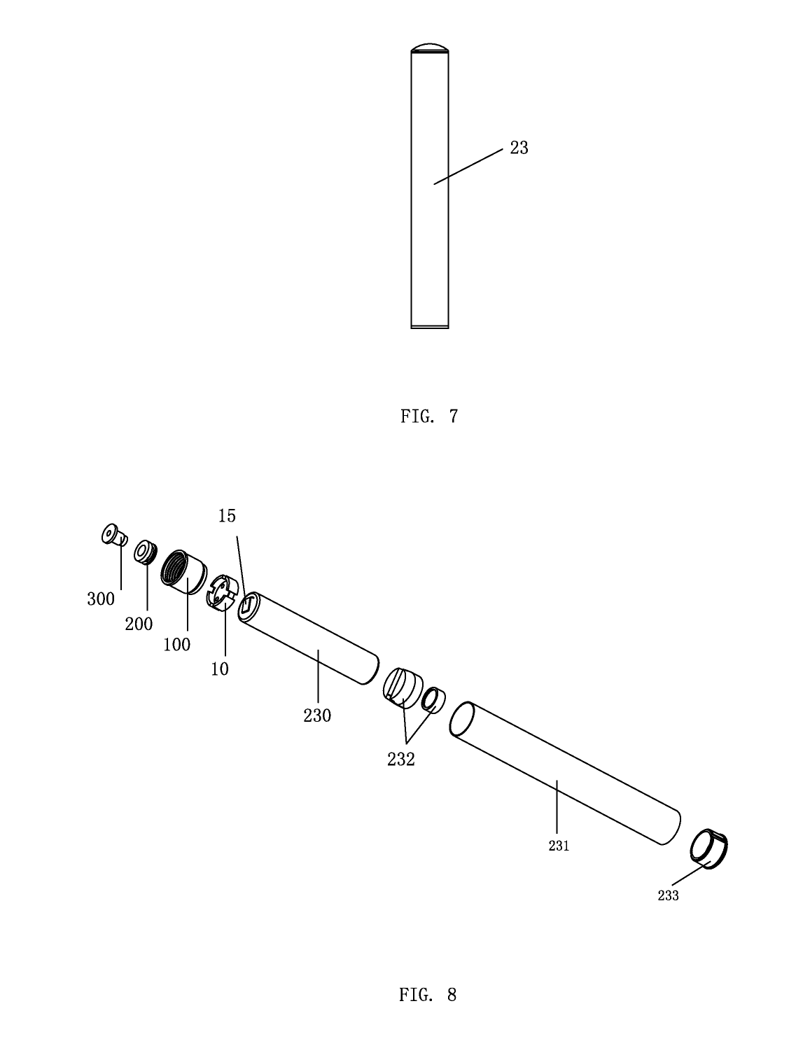

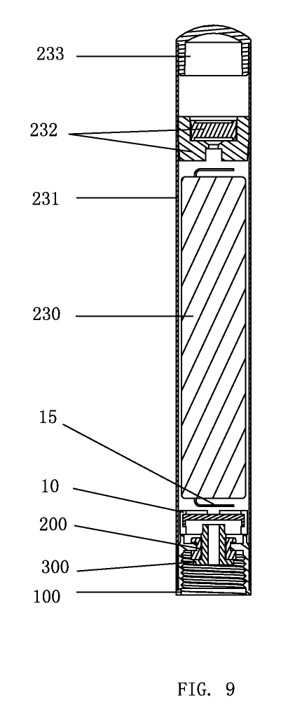

Referring to FIGS. 5-9, the present invention also provides an electronic cigarette 20 including an absorption stem 21 and a power source stem 23 connected to the absorption stem 21. A battery 230 is disposed in the power source stem 23. As an embodiment, one end of the battery 230 opposing the absorption stem 21 is equipped with the abovementioned battery pole piece protective bracket 10. The protective trough covers the battery pole piece 15 such that the battery pole piece 15 at one end of the battery 230 susceptible to short circuit is insulated. As another embodiment, the battery pole piece protective bracket 10 is also disposed on the battery 230 at one end away from the absorption stem 21, and two protective troughs 13 cover two battery pole pieces 15 disposed at two ends respectively such that battery pole pieces 15 disposed at two ends of the battery 230 are insulated. The cross section of the battery pole piece protective bracket 10 matches an inner side of the power source stem 23. In other words, the battery pole piece protective bracket 10 is parallel with and secured into the power source stem 23 facilitating protection of the battery pole piece 15 and wire electrically coupled with the battery pole piece 15.

Reference is made to FIG. 2. The absorption stem 21 includes an absorption sleeve 210, an atomizer 211 disposed in the absorption sleeve 210, a nozzle case 213 disposed at one end of the absorption sleeve 210, and a first connector disposed at the other end of the absorption sleeve 210 for connecting with the power source stem 23.

The power source stem 23 includes a power source sleeve 231 and a battery 230 placed in the power source sleeve 231. One end of the power source sleeve 231 is provided with a second connector connected to the first connector, while the other end thereof is provided with a switch module 232 and a cap 233. A light emitting unit is disposed inside the cap 233. More particularly, the light emitting unit is a red LED lamp for simulating burning cigar so as to indicate status. The switch module 232 includes a bracket and a gas sensor held on the bracket.

Each of the first and second connectors is composed of an external electrode ring 100, an insulation ring 200, and an internal electrode 300 which are connected with each other sequentially. Here, the insulation ring 200 is intended for insulating the external electrode ring 100 from the internal electrode 300. The atomizer 211 includes an atomization chamber formed together by a liquid storage component 2110 and a guiding tube 2111 inserted one another and sealed at two ends, and a heater 2112 contained in the atomization chamber. The two ends of the atomization chamber are sealed respectively by a nozzle case 213 and an atomization bracket 212.

The heater 2112 includes a liquid guiding component of which two ends extend out of an outer wall of the guiding tube 2111 and are pressed against the liquid storage component 2110, and an electric heater coil enwound on an outer surface of the liquid guiding component. In this embodiment, the liquid storage component 2110 is oil storage cotton, the guiding tube 2111 is a glass fiber tube, and the liquid guiding component is an oil guiding rope.

Though various embodiments of the invention have been illustrated above, a person of ordinary skill in the art will understand that, variations and improvements made upon the illustrative embodiments fall within the scope of the invention, and the scope of the invention is only limited by the accompanying claims and their equivalents.

1. A battery pole piece protective bracket wherein it is entirely of a cylindrical shape; a wire passage is defined in the battery pole piece protective bracket and is axially extended through the same; and at least one end surface of the battery pole piece protective bracket is provided with a protective trough recessed from the end surface for preventing contact of the battery pole piece with an external element thus further avoiding short circuit.

2. The battery pole piece protective bracket according to claim 1, wherein a plurality of gas passages extended along an axial direction of the battery pole piece protective bracket is disposed on a side of the battery pole piece protective bracket for flowing of gas therethrough.

3. The battery pole piece protective bracket according to claim 2, wherein the wire passage is formed from the gas passage along the axial direction for receiving wires therein.

4. The battery pole piece protective bracket according to claim 1, wherein the wire passage is a through hole running axially across the battery pole piece protective bracket for passing through the wires.

5. An electronic cigarette comprising an absorption stem and a power source stem connected to the absorption stem; a battery is disposed in the power source stem; and one end portion of the battery is equipped with the battery pole piece protective bracket as recited claim 1.

6. The electronic cigarette according to claim 5, wherein the cross section of the battery pole piece protective bracket matches an inner side of the power source stem.

7. The electronic cigarette according to claim 5, wherein the battery pole piece protective bracket is disposed on the battery at one end opposing the absorption stem.

8. The electronic cigarette according to claim 7, wherein the battery pole piece protective bracket is also disposed on the battery at one end away from the absorption stem.

9. The electronic cigarette according to claim 5, wherein the absorption stem includes an absorption sleeve, an atomizer disposed in the absorption sleeve, a nozzle case disposed at one end of the absorption sleeve, and a first connector disposed at the other end of the absorption sleeve for connecting with the power source stem.

10. The electronic cigarette according to claim 9, wherein the power source stem includes a power source sleeve and a battery placed in the power source sleeve; and one end of the power source sleeve is provided with a second connector connected to the first connector, while the other end thereof is provided with a switch module and a cap.

11. The electronic cigarette according to claim 10, wherein each of the first and second connectors is composed of an external electrode ring, an insulation ring, and an internal electrode which are connected with each other sequentially.

12. The electronic cigarette according to claim 9, wherein the atomizer includes an atomization chamber formed together by a liquid storage component and a guiding tube inserted one another and sealed at two ends, and a heater contained in the atomization chamber.

13. The electronic cigarette according to claim 12, wherein the heater includes a liquid guiding component of which two ends extend out of an outer wall of the guiding tube and are pressed against the liquid storage component, and an electric heater coil enwound on an outer surface of the liquid guiding component.

14. The electronic cigarette according to claim 12, wherein the two ends of the atomization chamber are sealed respectively by the nozzle case and an atomization bracket.
